(19) United States
(12) Patent Application Publication
(10) Pub. No.: US 2007/0053283 A1
(43) Pub. Date: Mar. 8, 2007

(54) Correlation and consolidation of link events to facilitate updating of status of source-destination routes in a multi-path network

(75) Inventors: Bret G. Bidwell, Hopewell Junction, NY (US); Aruna V. Ramanan, Poughkeepsie, NY (US); Nicholas P. Rash, Poughkeepsie, NY (US); Karen F. Rash, Poughkeepsie, NY (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 11/220,163

(22) Filed: Sep. 6, 2005

(51) Int. Cl. H04L 12/56; H04J 1/16; H04J 3/14; H04L 12/28

(52) U.S. Cl. 370/216; 370/242; 370/400

(57) ABSTRACT

In a communications network having a plurality of interconnected nodes adapted to communicate with each other by transmitting packets over links, with more than one path available between source-destination node pairs, a network interface is associated with each node. Each network interface has a plurality of route tables for defining a plurality of routes for transferring packets from the associated node as source node to a destination node. Each network interface further includes a path status table of path status indicators, e.g., bits, for indicating whether each route in the route table is usable or unusable as being associated with a fault. A network manager monitors the network to identify link events, and provides path status indicators to the respective network interfaces. The network manager determines the path status indicator updates with reference to a link level of each link event, and consolidates multiple substantially simultaneous link events.

### CROSS-REFERENCE TO RELATED APPLICATIONS

This application contains subject matter which is related to the subject matter of the following co-pending applications, each of which is assigned to the same assignee as this application. Each of the below-listed applications is hereby incorporated herein by reference in its entirety:

“Fanning Route Generation Technique for Multi-Path Networks”, Ramanan et al., Ser. No. 09/993,268, filed Nov. 19, 2001;

“Divide and Conquer Route Generation Technique for Distributed Selection of Routes Within A Multi-Path Network”, Aruna V. Ramanan, Ser. No. 11/141,185, filed May 31, 2005; and

“Reliable Message Transfer Over An Unreliable Network”, Bender et al., Ser. No. ______, filed Aug. 24, 2005 (Attorney Docket No. POU920050041US1).

### TECHNICAL FIELD

The present invention relates generally to communications networks and multiprocessing systems or networks having a shared communications fabric. More particularly, the invention relates to efficient techniques for correlating a link event to particular nodes in a multi-path network to facilitate updating of status of source-destination routes in the effected nodes, as well as to a technique for consolidating multiple substantially simultaneous link events within the network to facilitate updating of status of source-destination routes in the effected nodes.

### BACKGROUND OF THE INVENTION

Parallel computer systems have proven to be an expedient solution for achieving greatly increased processing speeds heretofore beyond the capabilities of conventional computational architectures. With the advent of massively parallel processing machines such as the IBM® RS/6000® SP1™ and the IBM® RS/6000® SP2™, volumes of data may be efficiently managed and complex computations may be rapidly performed. (IBM and RS/6000 are registered trademarks of International Business Machines Corporation, Old Orchard Road, Armonk, N.Y., the assignee of the present application.)

A typical massively parallel processing system may include a relatively large number, often in the hundreds or even thousands of separate, though relatively simple, microprocessor-based nodes which are interconnected via a communications fabric comprising a high speed packet switch network. Messages in the form of packets are routed over the network between the nodes enabling communication therebetween. As one example, a node may comprise a microprocessor and associated support circuitry such as random access memory (RAM), read only memory (ROM), and input/output (I/O) circuitry which may further include a communications subsystem having an interface for enabling the node to communicate through the network.

Among the wide variety of available forms of packet networks currently available, perhaps the most traditional architecture implements a multi-stage interconnected arrangement of relatively small cross point switches, with each switch typically being an N-port bidirectional router where N is usually either 4 or 8, with each of the N ports internally interconnected via a cross point matrix. For purposes herein, the switch may be considered an 8 port router switch. In such a network, each switch in one stage, beginning at one side (so-called input side) of the network, is interconnected through a unique path (typically a byte-wide physical connection) to a switch in the next succeeding stage, and so forth until the last stage is reached at an opposite side (so called output side) of the network. The bi-directional router switch included in this network is generally available as a single integrated circuit (i.e., a “switch chip”) which is operationally non-blocking, and accordingly a popular design choice. Such a switch chip is described in U.S. Pat. No. 5,546,391 entitled “A Central Shared Queue Based Time Multiplexed Packet Switch With Deadlock Avoidance” by P. Hochschild et al., issued on Aug. 31, 1996.

A switching network typically comprises a number of these switch chips organized into interconnected stages, for example, a four switch chip input stage followed by a four switch chip output stage, all of the eight switch chips being included on a single switch board. With such an arrangement, messages passing between any two ports on different switch chips in the input stage would first be routed through the switch chip in the input stage that contains the source or input port, to any of the four switches comprising the output stage and subsequently, through the switch chip in the output stage the message would be routed back (i.e., the message packet would reverse its direction) to the switch chip in the input stage including the destination (output) port for the message. Alternatively, in larger systems comprising a plurality of such switch boards, messages may be routed from a processing node, through a switch chip in the input stage of the switch board to a switch chip in the output stage of the switch board and from the output stage switch chip to another interconnected switch board (and thereon to a switch chip in the input stage). Within an exemplary switch board, switch chips that are directly linked to nodes are termed node switch chips (NSCs) and those which are connected directly to other switch boards are termed link switch chips (LSCs).

Switch boards of the type described above may simply interconnect a plurality of nodes, or alternatively, in larger systems, a plurality of interconnected switch boards may have their input stages connected to nodes and their output stages connected to other switch boards, these are termed node switch boards (NSBs). Even more complex switching networks may comprise intermediate stage switch boards which are interposed between and interconnect a plurality of NSBs. These intermediate switch boards (ISBs) serve as a conduit for routing message packets between nodes coupled to switches in a first and a second NSB.

Switching networks are described further in U.S. Pat. Nos. 6,021,442; 5,884,090; 5,812,549; 5,453,978; and 5,355,364, each of which is hereby incorporated herein by reference in its entirety.

Various techniques have been used for generating routes in a multi-path network. While some techniques generate routes dynamically, others generate static routes based on the connectivity of the network. Dynamic methods are often self-adjusting to variations in traffic patterns and tend to achieve as even a flow of traffic as possible. Static methods, on the other hand, are pre-computed and do not change during the normal operation of the network. Further, routes for transmitting packets in a multistage packet switched network can either be source based or destination based. In source based routing, the source determines the route along which the packet is to be sent and sends it along with the packet. The intermediate switching points route the packet according to the passed route information. Alternatively, in destination based routing, the source places the destination identifier in the packet and injects it into the network. The switching points will either contain a routing table or logic to determine how the packet needs to be sent out. In either case, the method to determine the route can be static or dynamic, or some combination of static and dynamic routing.

One common technique for sending packets between source-destination pairs in a multi-path network is static, source-based routing. For example, reference the above-incorporated co-pending applications, as well as the High-Performance Switch (HPS) released by International Business Machines Corporation, one embodiment of which is described in “An Introduction to the New IBM eServer pSeries® High Performance Switch,” SG24-6978-00, December 2003, which is hereby incorporated herein by reference in its entirety. As described in these co-pending applications, a suitable algorithm is employed to generate routes to satisfy certain pre-conditions, and these routes are stored in node tables, which grow with the size of the network. When a packet is to be sent from a source node to a destination, the source node references its route tables, selects a route to the destination and sends the route information along with the packet into the network. Each intermediate switching point looks at the route information and determines the port through which the packet should be routed at that point.

In a multi-stage network, any given link in the network will be part of routes between a set of source-destination pairs, which themselves will be a subset of all source-destination pairs of the network. If reliable message transfer is to be maintained, an approach is needed to efficiently and quickly identify routes affected by a link event and take appropriate action dependent on the event. The present invention addresses this need in both the case of a single link event, and multiple substantially simultaneous link events.

### SUMMARY OF THE INVENTION

The shortcomings of the prior art are overcome and additional advantages are provided through the provision of a communications network which includes a network of interconnected nodes. The nodes are at least partially interconnected by links, and are adapted to communicate by transmitting packets over the links. Each node has an associated network interface which defines a plurality of routes for transferring packets from that node as source node to a destination node, and further includes path status indicators for indicating whether a route is usable or is unusable as being associated with a fault. The network further includes a network manager for monitoring the network of interconnected nodes and noting a link event therein. Responsive to the presence of a link event, the network manager determines, with reference to an ascertained link level within the network of the link event, path status indicator updates to be provided to the respective network interfaces of effected nodes in the network of interconnected nodes.

In another aspect, a method of maintaining communication among a plurality of nodes in a network is provided. The method includes: defining a plurality of static routes for transferring a packet from a respective node as source node to a destination node in the network; monitoring the network to identify a link event within the network; providing path status indicators to at least some nodes of the plurality of nodes for indicating whether a source-destination route is usable or is unusable as being associated with a link fault; and employing a network manager to monitor the network for link events, and upon noting a link event, for determining, with reference to an ascertained link level within the network of the link event, path status indicator updates to be provided to the respective network interface of effected nodes of the network of interconnected nodes.

In a further aspect, at least one program storage device is provided readable by a machine, tangibly embodying at least one program of instructions executable by the machine to perform a method of maintaining communication among a plurality of nodes in a network of interconnected nodes. The method again includes: defining a plurality of static routes for transferring a packet from a respective node as source node to a destination node in the network; monitoring the network to identify a link event within the network; providing path status indicators to at least some nodes of the plurality of nodes for indicating whether a source-destination route is usable or is unusable as being associated with a link fault; and employing a network manager to monitor the network for link events, and upon noting a link event, for determining, with reference to an ascertained link level within the network of the link event, path status indicator updates to be provided to the respective network interface of effected nodes of the network of interconnected nodes.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a simplified model of a cluster network of a type managed by a service network, in accordance with an aspect of the present invention;

FIG. 2 schematically illustrates components of an exemplary cluster system, in accordance with an aspect of the present invention;

FIG. 3 depicts one embodiment of a switch board with eight switch chips which can be employed in a communications network that is to utilize a link event correlation and consolidation facility, in accordance with an aspect of the present invention;

FIG. 4 depicts one logical layout of switchboards in a 128-node system to employ a link event correlation and consolidation facility, in accordance with an aspect of the present invention;

FIG. 5 depicts the 128-node system layout of FIG. 4 showing link connections between node switchboard 1 (NSB1) and node switchboard 4 (NSB4);

FIG. 6 depicts the 128-node system layout of FIG. 4 showing link connections between node switchboard 1 (NSB1) and node switchboard 5 (NSB5);

FIG. 7 depicts one embodiment of a 256 endpoint switch block, employed in a communications network, in accordance with an aspect of the present invention;

FIG. 8 depicts a schematic of one embodiment of a 2048 endpoint communications network employing the 256 endpoint switch block of FIG. 7, and to employ a link event correlation and consolidation facility, in accordance with an aspect of the present invention;

FIG. 9 is a flowchart of one embodiment of an exemplary process for updating of a node's path table array, in accordance with an aspect of the present invention;

FIG. 10 depicts exemplary route table array and path table array structures of a node's switch network interface, in accordance with an aspect of the present invention;

FIG. 11 is a flowchart of one embodiment of a link event correlation and path table update process, in accordance with an aspect of the present invention;

FIG. 12 is a flowchart of one embodiment of a link event collection process, in accordance with an aspect of the present invention;

FIG. 13 depicts an example consolidation chart for multiple link fault events occurring within a predefined time interval of each other, in accordance with an aspect of the present invention;

FIG. 14 is a flowchart of one embodiment of a process for consolidating multiple collected link events, in accordance with an aspect of the present invention; and

FIGS. 15A & 15B are a flowchart of one embodiment of a process for transitioning a modification type flag for a node responsive to a link event, wherein the transition process is dependent on the link level of the link event, in accordance with an aspect of the present invention.

### BEST MODE FOR CARRYING OUT THE INVENTION

Generally stated, this invention relates in one aspect to handling of situations in systems in which one or more faults, each requiring one or many repair actions, may occur. The repair actions themselves span a set of hierarchical steps in which a higher level action encompasses levels beneath that level. A centralized manager, referred to herein as the network manager, is notified by network hardware of a link fault occurring within the network, and is required to direct or take appropriate actions. At times, these repair actions can become time-critical. One particular type of system which faces this time-critical repair action is a networked computing cluster. This disclosure utilizes the example of a cluster of hosts interconnected by a regular, multi-state interconnection network and illustrates solutions to the problem.

As noted above, a common method for sending packets between source-destination pairs in a multi-stage packet switched network of interconnected nodes is static, source-based routing. When such a method is employed, sources maintain statically computed route tables which identify routes to all destinations in the network. Typically, a suitable algorithm is used to generate routes that satisfy certain preconditions, and these routes are stored in tables which grow with the size of the network. When a packet is to be sent to a destination, the source will look up the route table, select a route to that destination and send the route information along with the packet. Intermediate switching points examine the route information and determine the port through which the packet should be routed at each point.

In a multi-stage network, any given link in the network may be part of multiple routes between a set of source-destination pairs, which will be a subset of all the source-destination pairs of the network. If reliable message transfer is to be maintained, it becomes necessary to quickly identify the routes effected by a link event, such as a link failure, and take appropriate recovery action. The recovery action may be replacing the failed route by a good route, or simply avoiding the failed route, as described further in the above-referenced incorporated, co-pending application entitled “Reliable Message Transfer Over an Unreliable Network.” For any recovery action, it is important to identify the set of failed routes so that the recovery action can be performed efficiently.

When the routes themselves are compactly encoded in a form that can be understood by logic at the switching points, they may not contain the identity of the links used by each hop in the route. One direct method to identify routes effected by a link failure is to reverse map the routes on the links and maintain the information in the network manager that is responsible for the initial route generation, as well as the repair action. Such reverse maps would require a very large storage for large networks. Thus, a technique that avoids the creation and maintenance of reverse maps to help repair actions would be desirable.

Further, when multiple faults, each requiring one of many recovery actions, occur substantially simultaneously (i.e., within a defined time interval of each other), then the recovery or repair actions are preferably consolidated. It is possible that the repair actions themselves span a set of hierarchical steps in which a higher level action encompasses all levels beneath that level. An efficient technique is thus described herein to consolidate repair actions and maintain packet transport when multiple link failures occur substantially simultaneously.

The present invention relates in one aspect to a method to quickly and efficiently correlate and consolidate link events, i.e., a faulty link or a recovered link, occurring in a network of interconnected nodes, without maintaining a reverse map of the source-destination routes employed by the nodes. The solution presented herein recognizes the connection between the level of links in a multi-stage network and the route generation algorithm employed, and identifies source nodes whose routes are effected by a certain link event, and categorizes them in terms of the extent of repair action needed. It also presents a technique to collect fault data relating to multiple faults occurring close to each other, and analyze them to derive a consolidated repair action that will be completed within a stipulated time interval.

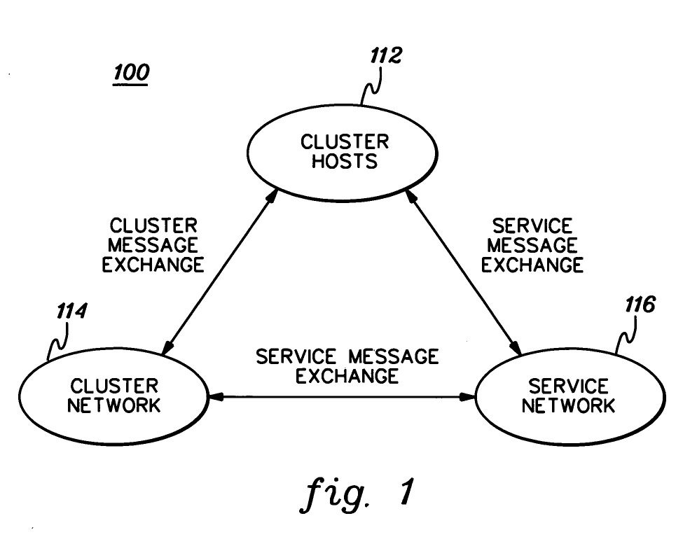

Referring to the drawings, FIG. 1 illustrates a simplified model of a cluster system 100 comprising a plurality of servers, or cluster hosts 112, connected together using a cluster network 114 managed by a service network 116, e.g., such as in a clustered supercomputer system. As illustrated, messages are exchanged among all entities therein, i.e., cluster messages between cluster hosts 112 and cluster network 114; service messages between cluster hosts 112 and service network 116; and service messages between service network 116 and cluster network 114. To achieve high performance, such networks and servers rely on fast, reliable message transfers to process applications as efficiently as possible.

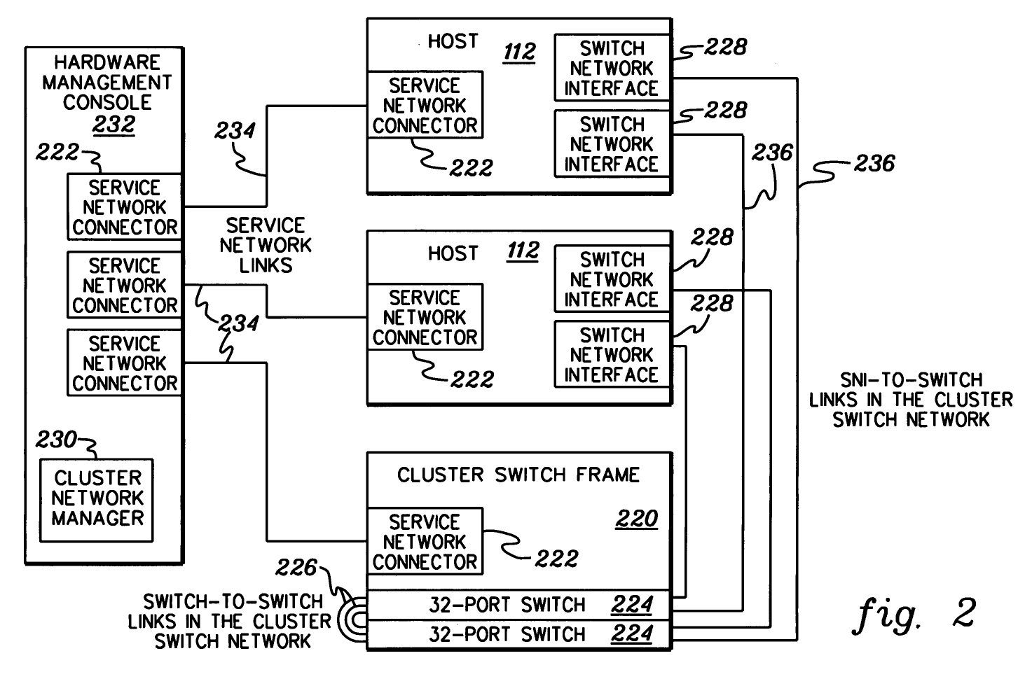

FIG. 2 schematically illustrates an exemplary embodiment of a cluster system in accordance with the present invention. The cluster system comprises a plurality of hosts 112, also referred to herein as clients or nodes, interconnected by a plurality of switches, or switching elements, 224 of the cluster network 114 (see FIG. 1). Cluster switch frame 220 houses a service network connector 222 and the plurality of switching elements 224, illustrated in FIG. 2 as two switching elements by way of example only. Switching elements 224 are connected by links 226 in the cluster switch network such that there is more than one way to move a packet from one host to another, i.e., a source node to a destination node. That is, there is more than one path available between most host pairs.

Packets are injected into and retrieved from the cluster network using switch network interfaces 228, or specially designed adapters, between the hosts and the cluster network. Each switch network interface 228 comprises a plurality, and preferably three or more, route tables. Each route table is indexed by a destination identifier. In particular, each entry in the route table defines a unique route that will move an incoming packet to the destination defined by its index. The routes typically span one or more switching elements and two or more links in the cluster network. The format of the route table is determined by the network architecture. In an exemplary embodiment, four predetermined routes are selected from among the plurality of routes available between a source and destination node-pair. A set of routes thus determined between a source and all other destinations in the network are placed on the source in the form of route tables. During cluster operation, when a source node needs to send a packet to a specific destination node, one of the (e.g., four) routes from the route table is selected as the path for sending the packet.

In an exemplary embodiment, as illustrated in FIG. 2, the cluster network is managed by a cluster network manager 230 running on a network controller, referenced in FIG. 2 as the management console 232. In particular, in the illustrated embodiment, the management console is shown as comprising hardware, by way of example, and has a plurality of service network connectors 222 coupled over service network links 234 to service network connectors 222 in the hosts and cluster switch frames. The switch network interfaces (SNI) 228 in the hosts are connected to the switching elements 224 in the cluster switch frame 220 via SNI-to-switch links 236. In an exemplary embodiment, cluster network manager 230 comprises software. The network controller is part of a separate service network 116 (see FIG. 1) that manages, or administers, the cluster network. The network manager is responsible for initializing and monitoring the network. In particular, the network manager calls out repair actions in addition to computing and delivering the route tables to the cluster network hosts. Although certain aspects of this invention are illustrated herein as comprising software or hardware, for example, it will be understood by those skilled in the art that other implementations may comprise hardware, software, firmware, or any combination thereof.

In accordance with an aspect of the present invention, the network manager identifies faults in the network in order to determine which of the routes, if any, on any of the hosts are affected by a failure within the network. In an exemplary embodiment, the switch network interface 128 (see FIG. 1) provides for setting of preferred bits in a path table to indicate whether a particular static route to a specific destination is preferred or not. In an exemplary embodiment, the path table comprises hardware; and faulty paths in a network are avoided by turning off the preferred bits associated with the respective faulty routes. When the switch network interface on a source node, or host, receives a packet to be sent to a destination, it will select one of the routes that has its preferred bits turned on. Thus, by toggling a preferred bit from a preferred to not-preferred state when a route corresponding to the bit is unusable due to a link failure on the route, then an alternative one of the routes in the route table will be used. The need for modification of the route for the particular message is thus advantageously avoided. When the failed link is restored, the route is usable again, and the path table preferred bit is toggled back again to its preferred state. Advantageously, the balance of routes employed is restored when all link faults are repaired, without the need for modifying the route or establishing a different route. Balancing usage of message routes in this manner thus provides a more favorable distribution, i.e., preferably an even distribution, of message traffic in the network. This effect of maintaining the relative balance of route usage may be more pronounced in relatively large networks, i.e., those having an even greater potential of losing links.

Another advantage of the technique for providing reliable message transfer in accordance with aspects of the present invention is that the global knowledge of the network status is maintained by the network manager 230 (see FIG. 2). That is, the network manager detects failed components, determines which paths are affected between all source-destination node-pairs, and turns off the path status bits in the appropriate route tables. In this way, attempts at packet transmissions over faulty paths are avoided.

Yet another advantage of the present invention is that all paths that fail due to a link failure are marked unusable by the network manager by turning their path status bits off. While prior methods rely on message delivery failure to detect a failed path, the present invention has the capability to detect and avoid failures before they occur.

Still a further advantage of the present invention is that when a failed path becomes usable again, the network manager merely turns the appropriate path status bits back on. This is opposed to prior methods that require testing the path before path usage is reinstated. Such testing by attempting message transmission is not needed in accordance with the present invention.

Aspects of the present invention are illustratively described herein in the context of a massively parallel processing system, and particularly within a high performance communication network employed within the IBM® RS/6000® SP™ and IBM eServer pSeries® families of Scalable Parallel Processing Systems manufactured by International Business Machines (IBM) Corporation of Armonk, N.Y.

As briefly noted, the correlation and consolidation facility of the present invention is described herein, by way of example, in connection with a multi-stage packet-switch network. In one embodiment, the network may comprise the switching network employed in IBM's SP™ systems. The nodes in an SP system are interconnected by a bi-directional multi-stage network. Each node sends and receives messages from other nodes in the form of packets. The source node incorporates the routing information into packet headers so that the switching elements can forward the packets along the right path to a destination. A Route Table Generator (RTG) implements the IBM SP2™ approach to computing multiple paths (the standard is four) between all source-destination pairs. The RTG is conventionally based on a breadth first search algorithm.

Before proceeding further, certain terms employed in this description are defined:

SP System: For the purpose of this document, IBM's SP™ system means generally a set of nodes interconnected by a switch fabric.

Node: The term node refers to, e.g., processors that communicate amongst themselves through a switch fabric.

N-way System: An SP system is classified as an N-way system, where N is a maximum number of nodes that can be supported by the configuration.

Switch Fabric: The switch fabric is the set of switching elements or switch chips interconnected by communication links. Not all switch chips on the fabric are connected to nodes.

Switch Chip: A switch chip is, for example, an eight port cross-bar device with bi-directional ports that is capable of routing a packet entering through any of the eight input channels to any of the eight output channels.

Switch Board: Physically, a Switch Board is the basic unit of the switch fabric. It contains in one example eight switch chips. Depending on the configuration of the systems, a certain number of switch boards are linked together to form a switch fabric. Not all switch boards in the system may be directly linked to nodes.

Link: The term link is used to refer to a connection between a node and a switch chip, or two switch chips on the same board or on different switch boards.

Node Switch Board: Switch boards directly linked to nodes are called Node Switch Boards (NSBs). Up to 16 nodes can be linked to an NSB.

Intermediate Switch Board: Switch boards that link NSBs in large SP systems are referred to as Intermediate Switch Boards (ISBs). A node cannot be directly linked to an ISB. Systems with ISBs typically contain 4, 8 or 16 ISBs. An ISB can also be thought of generally as an intermediate stage.

Route: A route is a path between any pair of nodes in a system, including the switch chips and links as necessary.

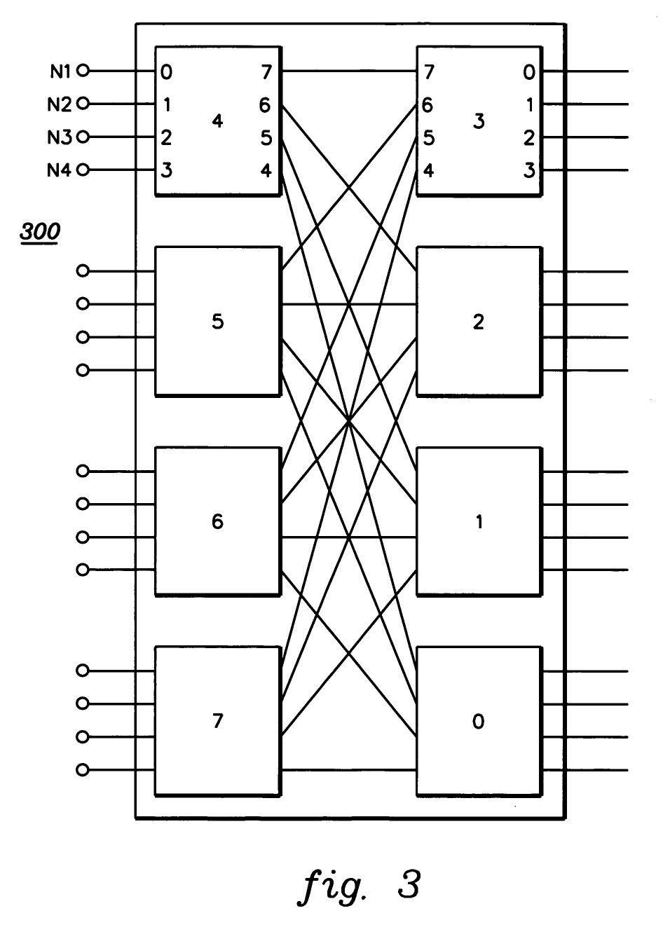

One embodiment of a switch board, generally denoted 300, is depicted in FIG. 3. This switch board includes eight switch chips, labeled chip 0-chip 7. As one example, chips 4-7 are assumed to be linked to nodes, with four nodes (i.e., N1-N4) labeled. Since switch board 300 is assumed to connect to nodes, the switch board comprises a node switch board or NSB.

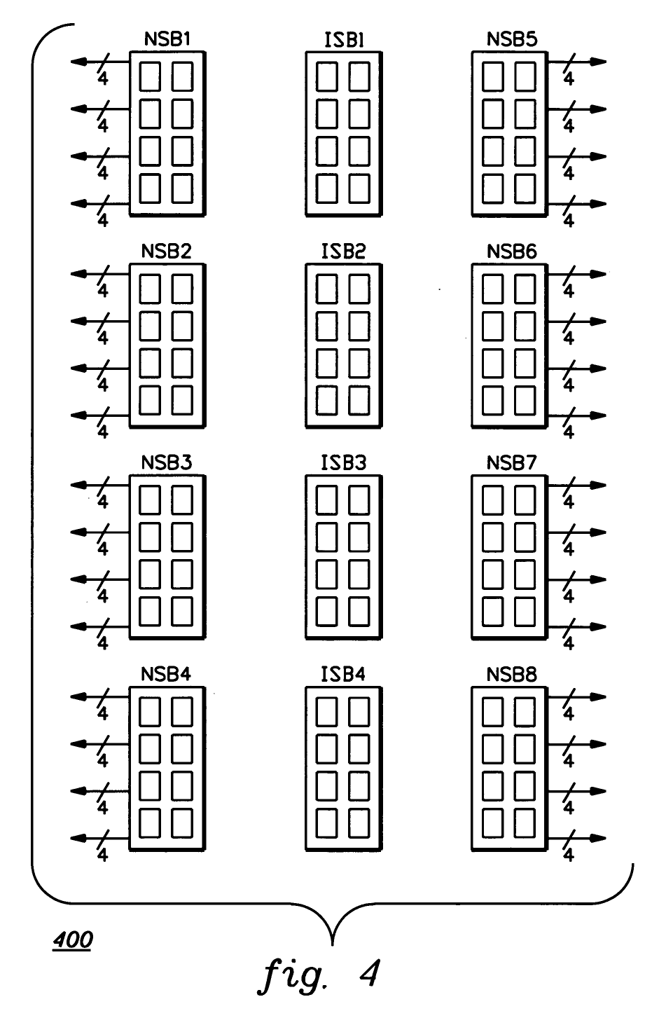

FIG. 4 depicts one embodiment of a logical layout of switch boards in a 128 node system, generally denoted 400. Within system 400, switch boards connected to nodes are node switch boards (labeled NSB1-NSB8), while switch boards that link the NSBs are intermediate switch boards (labeled ISB1-ISB4). Each output of NSB1-NSB8 can actually connect to four nodes.

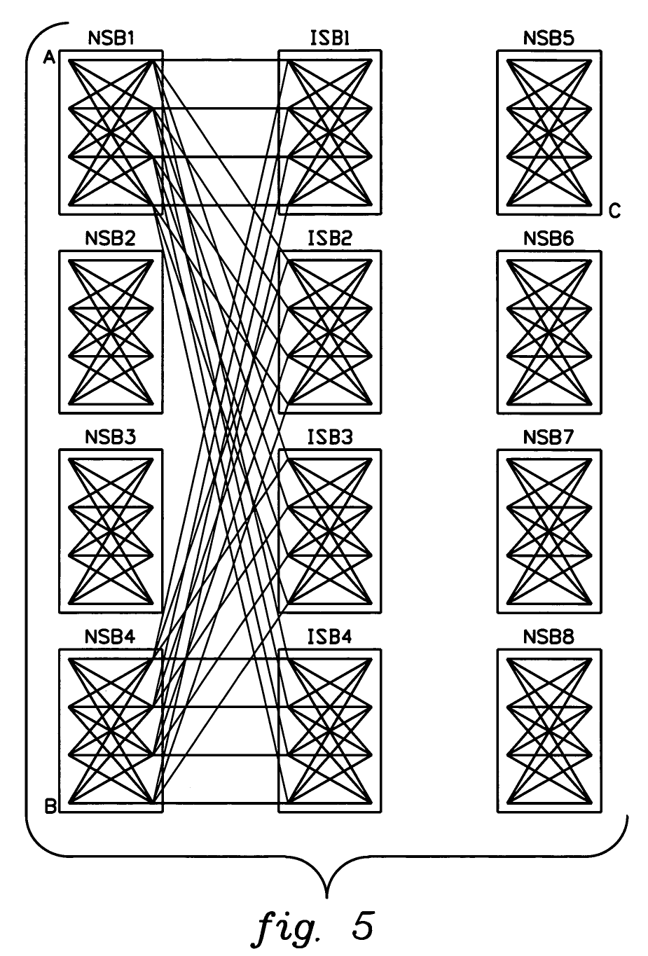

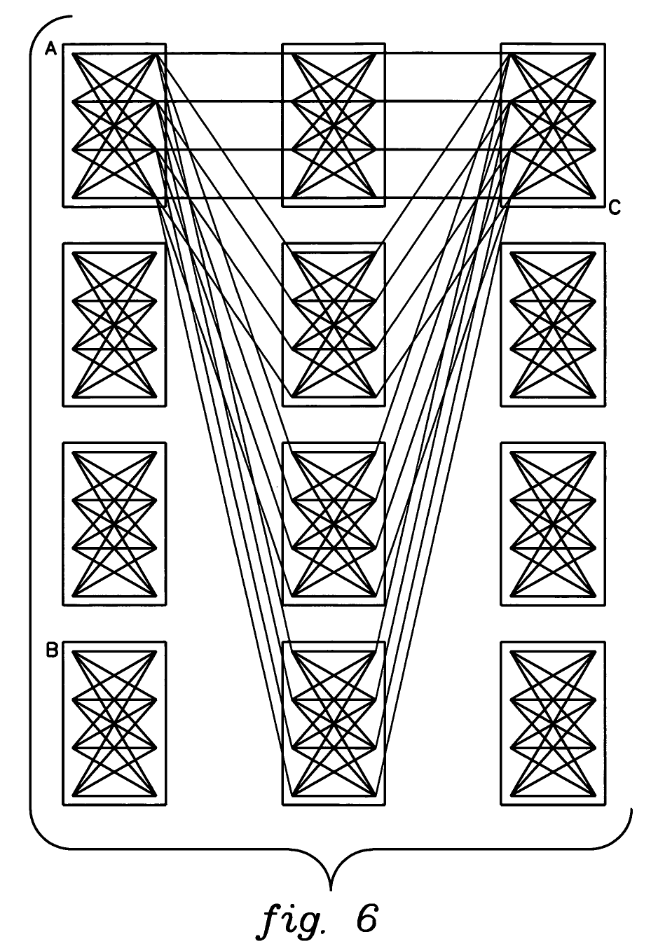

FIG. 5 depicts the 128 node layout of FIG. 4 showing link connections between NSB 1 and NSB4, while FIG. 6 depicts the 128 node layout of FIG. 4 showing link connections between NSB1 and NSB5.

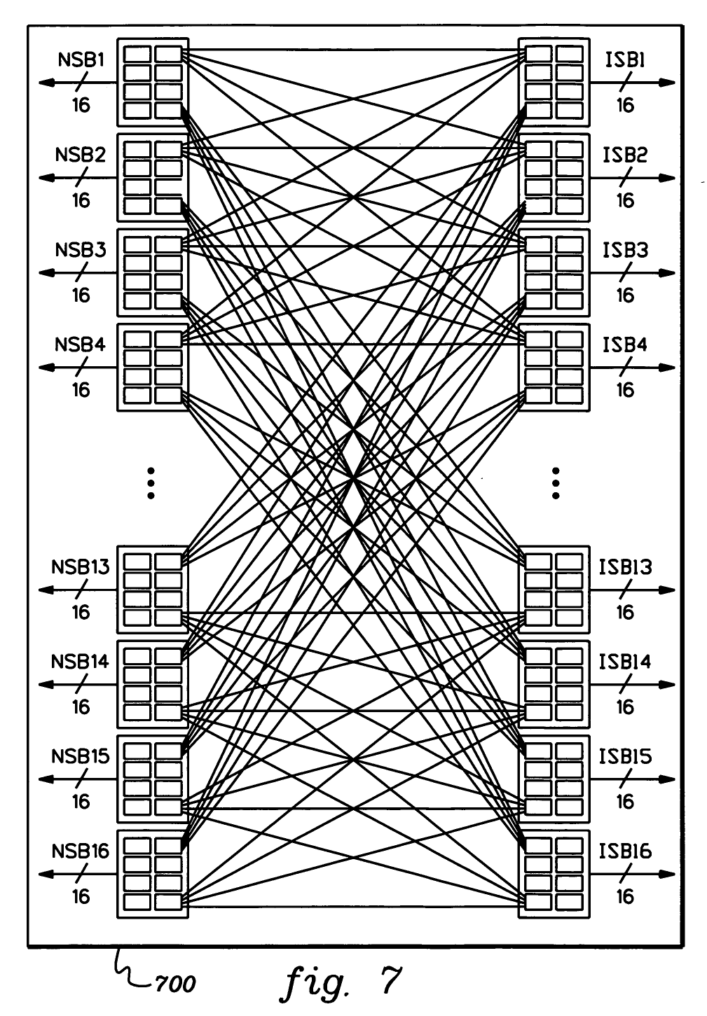

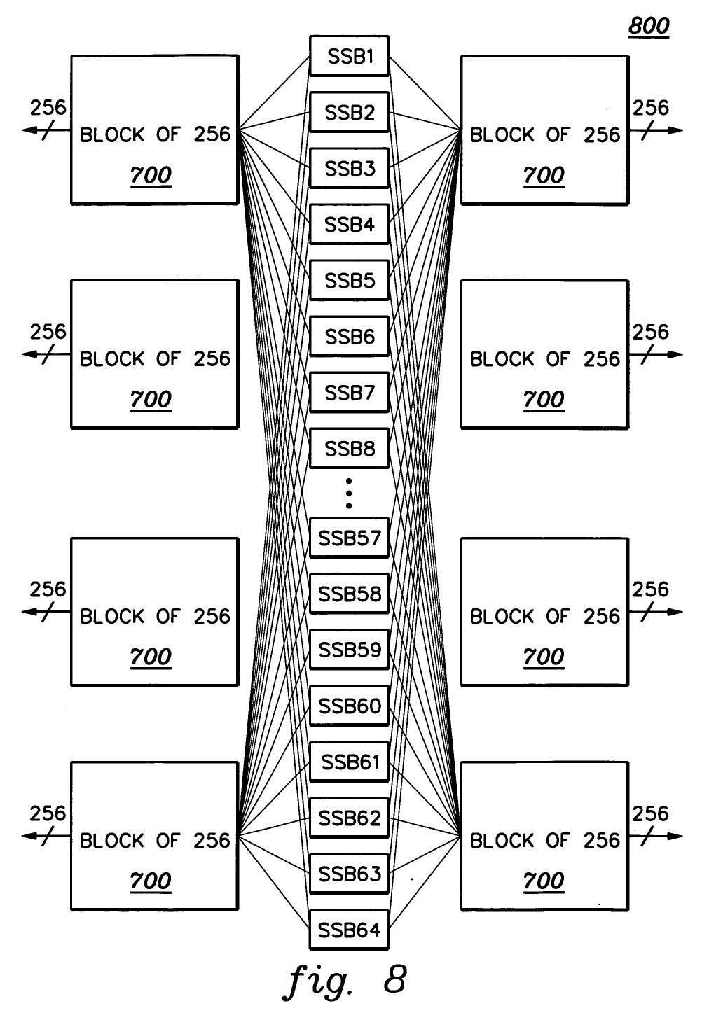

FIGS. 7 & 8 illustrate a large multi-stage network in which host nodes are connected on the periphery of the network, on the left and right sides of FIG. 8. This network includes sets of switchboards interconnected by lengths in a regular pattern. As shown in FIG. 7, the boards themselves contain eight switch chips, which form two stages of switching. The routes between source-destination pairs in this network are passed through multiple switch chips ranging from 1 to 10. In FIG. 7, a switch block of 256 endpoints 700 is illustrated wherein both node switchboards (NSBs) and intermediate switchboards (ISBs) are employed. Since each board can connect to 16 possible nodes, the switch block 700 is referred to as a 256 endpoint switch block. This block is then repeated eight times in the network of FIG. 8 to arrive at a 2048 endpoint network 800. The switch blocks 700 of 256 endpoints are interconnected via 64 secondary stage boards (SSBs), which are similar to the intermediate switchboards, and have similar internal chip and connections as illustrated in FIGS. 3, 5 & 6.

The correlation and consolidation facility disclosed herein categorizes links into various levels ranging from 0 to n−1. The links, connecting the network hosts to the peripheral switches are level 0 links, the on-board links on the peripheral switches are level 1 links, the links between the peripheral switches and the next stage of links are level 2 links, level 3 links are on the intermediate switch boards, level 4 links are between the blocks of 256 endpoints and the secondary switchboards (SSBs), and level 5 links are links on the secondary switchboards themselves. Depending upon the level of the link, a certain link has the potential to carry routes from or to specific sets of host nodes. Identification of the set of host nodes reduces the routes to be examined to a definite subset. Having found that subset, various methods described below can be used to identify the specific routes that are passing through the link.

In the example network of FIG. 8, the hosts, are connected to the links on the left and the right sides. Routes between hosts on the left to those on the right pass through all stages of switch chips. The routes between hosts on the same side reach a common bounce chip between the source and the destination and turn back to reach the destination. Such routes will have less than 10 hops, while the routes crossing the network will always have 10 hops. Since each link is bidirectional, a link potentially can support a route in both directions. This means for a link near the periphery there will be a small number of hosts having routes through the link to the rest of the hosts. Also, the rest of the hosts have a potential to use the link to those small number of hosts.

In this sample network, links at level 0, the ones that connect to the hosts, carry all the routes to and from the attached host nodes. The next level, i.e., level 1 links, are the links on board the NSBs. When a link at this level fails, one route to all off chip destinations from the four hosts or sources connected to the chip will fail. Also, one route from all off chip sources to the four destinations on this chip will fail. The next level is level 2, the links between NSBs and ISBs. When a link at this level fails, one route to all off board designations from the 16 sources on the NSB connected to the faulty link will fail. Also, one route from all off board sources to the 16 destinations on this NSB will fail. A level 3 fault will effect routes to and from 64 host nodes; a level 4 fault will effect routes to and from 256 host nodes; a level 5 fault, being at the center of the network, will effect routes between the 1024 hosts on one side and the 1024 hosts on the other side of the link.

Table 1 illustrates the number of source-destination pairs for the two modification types for each link level in a 2048-node network.

| | # of sources | | | |
|---|---|---|---|---|
| Level | with | Corresponding | # of sources | Corresponding |
| of | ModType = | Potential | with ModType = | Potential |
| Link | FULL | Destinations | PARTIAL | Destinations |
| 0 | 1 | 2047 | 2047 | 1 |
| 1 | 4 | 2044 | 2044 | 4 |
| 2 | 16 | 2032 | 2032 | 16 |
| 3 | 64 | 1984 | 1984 | 64 |
| 4 | 256 | 1792 | 1792 | 256 |
| 5 | 1024 | 1024 | 1024 | 1024 |

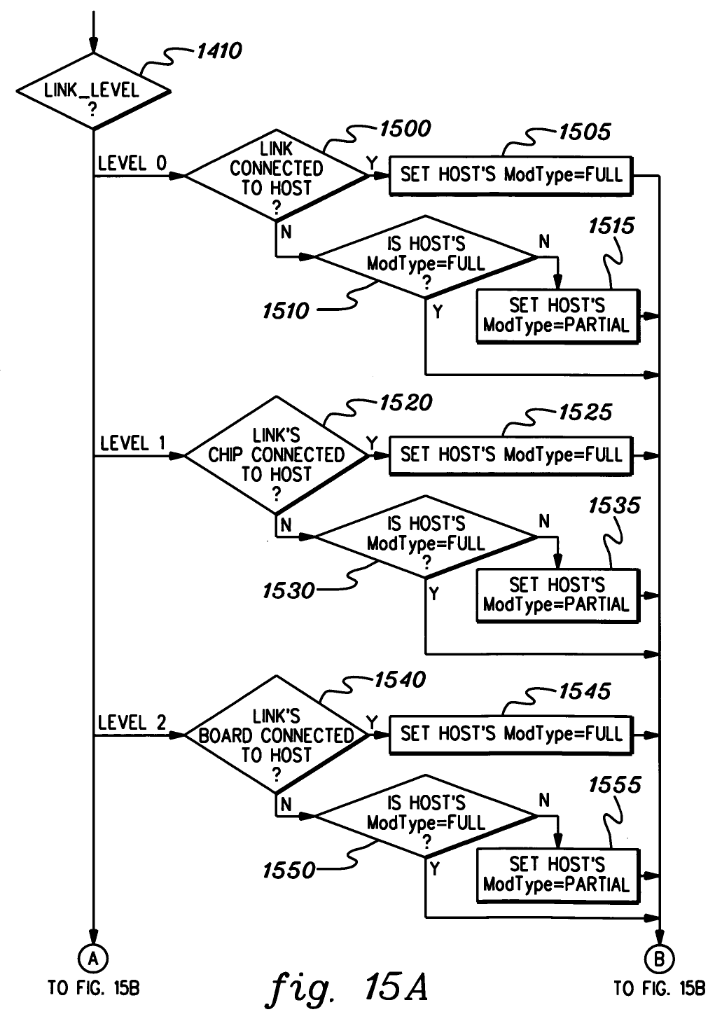

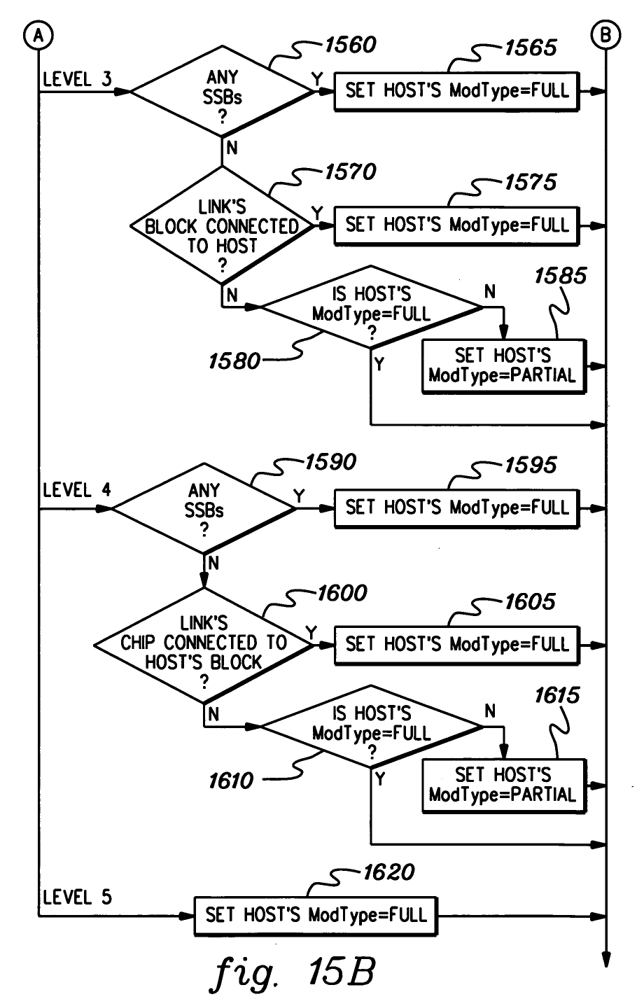

For illustration, reference FIGS. 7 & 8 and assume that a link at level 4 between top right block of 256 and SSB4 is bad. The hosts are numbered 0 to 2047 starting with the hosts connected to the top left block of 256 (FIG. 8) down and then continuing on the top right block of 256 and down. Thus, hosts 0-1023 are on the left, hosts 1024-1279 are on the top right block whose link to an SSB has failed, and 1280-2047 are on the other three blocks of 256 on the right. As described below with reference to FIGS. 15A & 15B, the algorithm will branch to level 4 (FIG. 15B) while processing this link down. The first decision “Any SSBs?” evaluates to yes. At the next decision box, the query “Link's chip connected to host's block?” will evaluate to “no” for hosts 0-1023 and 1280-2047. Since this link down is the first one seen, the current ModType is NONE and hence will transition to PARTIAL. The list of destinations that will be pushed into the destination list is 1024-1279 (256 destinations). The query “Link's chip connected to host's block?” will evaluate to “yes” for hosts 1024-1279 and hence the ModType for these will be set to FULL.

The top right block of 256 contains NSBs 65-80. Assume that a level 2 link between one of the NSB 65 NSBs and an ISB of the block is also faulty and is handled next. The link level query will branch to level 2 (FIG. 15A). The query “Link's board connected to host?” will evaluate to “yes” for 1264-1279. The ModType for these will be set to FULL again. The query will evaluate to “no” in all other cases. The next query “Is host's ModType=FULL?” will evaluate to “yes” for 1024-1263 and they will be left with ModType FULL. The other hosts will have their ModType set to PARTIAL with destinations 1264-1279 pushed to the destinations lists.

As noted below with reference to FIG. 14, if there are no more links in the status change list, then the next step is to remove duplicates. In this example, destinations 1264-1279 have been pushed twice and hence one instance will be removed.

Before describing the link event correlation and consolidation facility further, the repair process of the reliable message transfer described in the above-incorporated application entitled “Reliable Message Transfer Over an Unreliable Network” is reviewed.

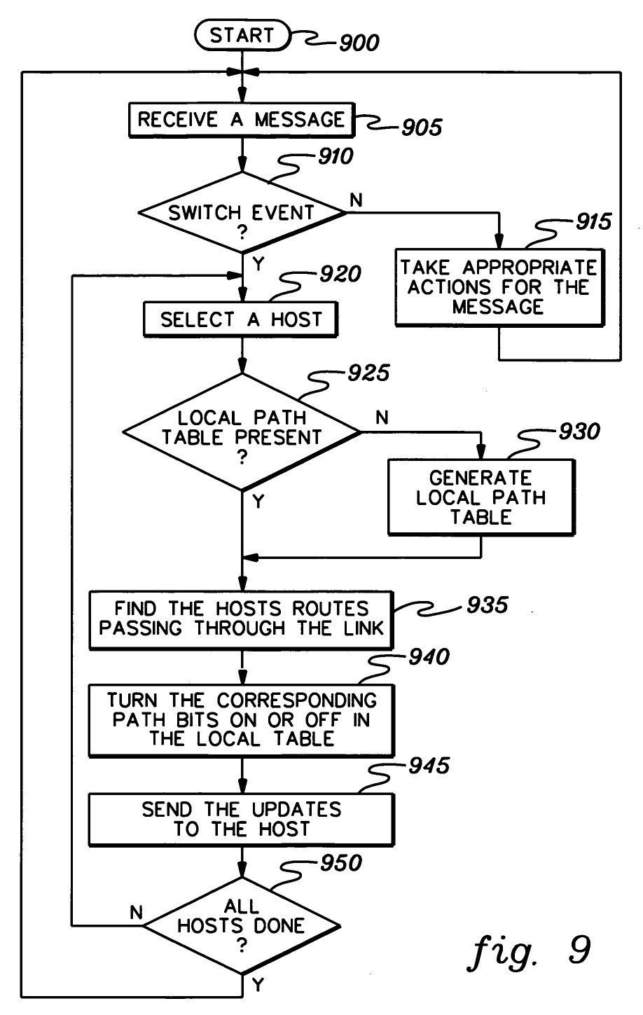

FIG. 9 is a flowchart illustrating update of a path table (i.e., preferred bit settings) in accordance with exemplary embodiments of the present invention. During operation of the cluster, the network may experience link outages or link recovery; and routes are accordingly removed or reinstated. In particular, whenever a link status change is identified, the path table is updated. As illustrated, upon starting 900, an incoming message on the service network is received by the cluster network manager in step 905. Then a query is made in step 910 as to whether this is a switch event, i.e., whether a link status change is identified, indicating that routes may have failed or restored. If not, as indicated in step 915, appropriate actions are taken as determined by the network manager. If it is a switch event indicating a link status change, however, then a host is selected in step 920. After the host is selected, a query is made in step 925 as to whether there is a local path table present for the host. If not, then the local path table is generated in step 930. If there is a local path table present, or after it is generated, then in step 935, the host's route passing through the link is determined. Next, in step 940, the corresponding path in the local table is turned on or off. In step 945, updates are sent to the host. A query is then made in step 950 as to whether all hosts have been processed. If not, the process returns to step 920; and when all hosts have been queried, the process repeats with receipt of a message in step 905.

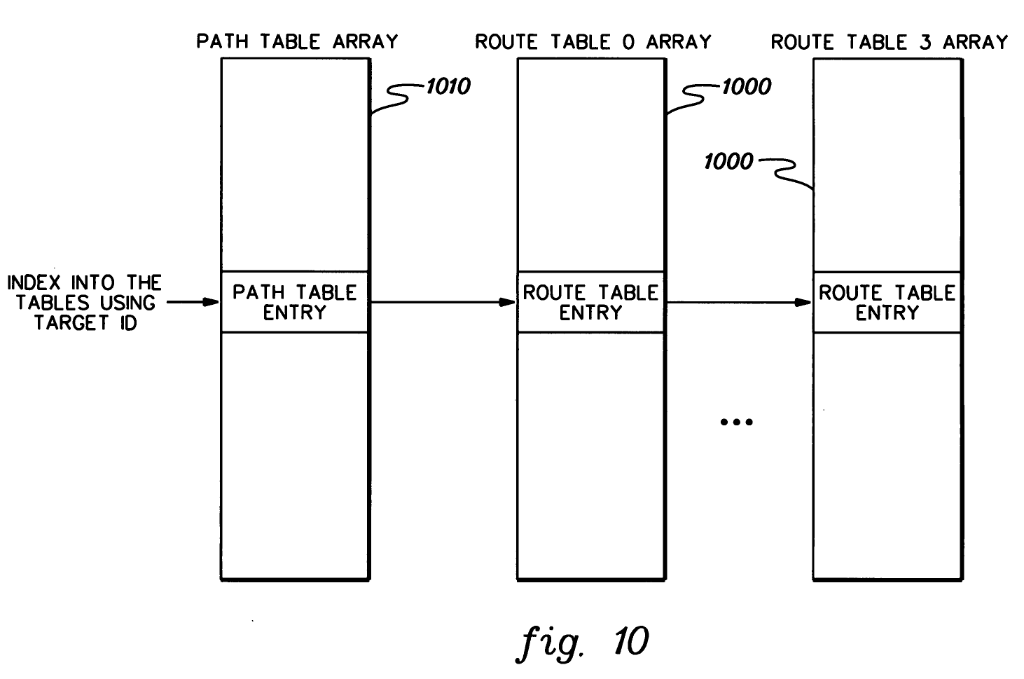

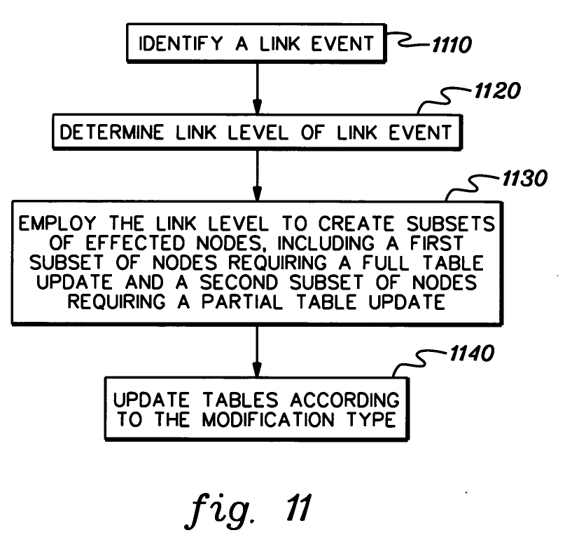

FIG. 10 illustrates exemplary route and path table structures for an embodiment of a switch network interface 228 (see FIG. 2). Each switch network interface comprises a plurality, i.e., preferably three or more, route tables 1000. Each entry in the route table defines a unique route for moving an incoming packet to its destination as specified by an index. In exemplary embodiments, each route spans one or more switching elements and two or more links in the cluster network. The format of the route table depends on the network architecture. A predetermined number of paths (e.g., four) are chosen from among the plurality of paths available between a source-destination node-pair to define the routes between the pair. A set of routes is thus defined between a source and all other destinations in the network; this set of routes is placed on the source in the form of route tables 1000. Path table 1010 contain preferred bit settings to indicate which routes in the route tables are usable.

Continuing with discussion of the link event correlation and consolidation facility, FIG. 11 depicts one embodiment of a facility for correlating a link event with effected nodes of a network of interconnected nodes employing link level of the link event, in accordance with an aspect of the present invention. In this process, a link event is identified 1100, for example, by network hardware forwarding a link failure indication to the network manager. The link level of the link event is then determined 1110, which can be readily identified by employing the above-noted link levels of the network. Thereafter, at least one subset of nodes requiring path status indicator updates is identified. In one example, two subsets are assembled. In a first subset, nodes requiring a FULL update of path status indicators are collected, while in a second subset, nodes requiring only PARTIAL updates of path status indicators are assembled. This assembling of subsets is analogous to the process set forth in FIGS. 15A & 15B, and described below with reference to multiple event failures.

When static routes are generated and stored in route tables on the host nodes, only a few of the many possible routes between a source-destination pair will be selected. In the cluster implementation, four such routes may be selected. So, it is obvious that not all hosts in the selected subsets will have routes to or from them passing through the failed link. In the repair action phase it is necessary to identify the routes which have the potential to be effected. The path table bit corresponding to any effected route should then be turned “off”. Similarly, the path table bit corresponding to any restored routes are turned “on” when links come back up. One direct method to find such routes passing through the failed link is to trace all routes to or from the hosts in the selected set hop-by-hop and determine those that pass through the link. A second method is to use the routing algorithm to identify the hosts whose routes pass through the failed link. Because of the regularity of the network, these are determinable algebraically. A third method can be implemented by creating a route mask built utilizing the specific connectivity and the structure of route words, which is then applied to all routes in the selected list to identify those passing through the failed link.

Consider host node 0 in the example network. Destinations 1024-1279 will be in its destination list. Choosing destination 1024, the possible routes between from 0 to 1024 will contain 10 hops, with a hop being defined by a port number through which the packet traveling on that route will exit a chip. All possible routes between 0 and 1024 can be represented by the set:

(4,5,6,7)-(0,1,2,3)-(4,5,6,7)-(0,1,2,3)-(4,5,6,7)-0-4-0-4-0

Four of these would have been placed in the route table. The network manager maintains a database of the links and devices in the network that contains their status and interconnectivity. While implementing the first method, status of each of these ports is checked in the database while walking through the route. A route is declared good if all intervening links between the source node and the destination node along the route are good. If any one link is bad, the route is declared bad and the corresponding path table bit is turned “off”. Of the two bad links in the above example, the first has the potential of being in the 6^{th} hop of the route between 0 and 1023. If it is found, the corresponding route is deemed bad.

When multiple links at different levels fail at the same time, a host may end up requiring multiple portions of its route tables to be examined. Identifying a superset of these sets would allow a single action to be taken. Thus, disclosed herein is a technique to collect and consolidate link events, and analyze them to come up with repair actions that can be completed within a stipulated time interval. The collection of event link data commences with receiving a first link event notification and a time interval is set within the total available time to collect any other faults/recoveries in the system. All gathered data is then analyzed and a unique set of repair actions is arrived at such that all collected link events are handled.

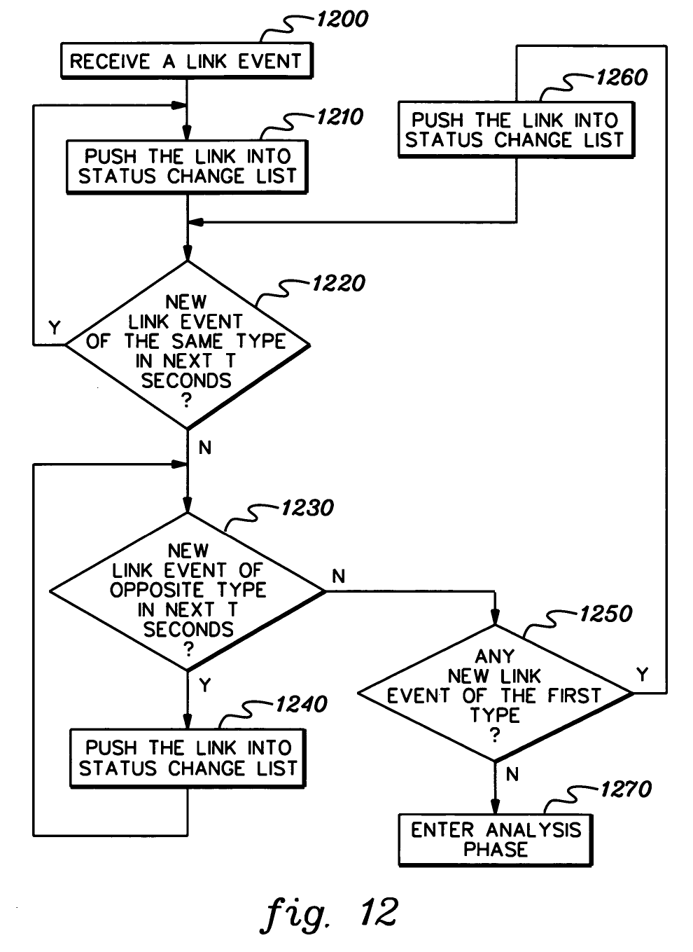

In describing the consolidation facility with reference to FIGS. 12-15B, the network is again assumed to comprise regularly connected switch boards, each of which contains two stages of switching elements which are connected to each other. Each switching element or chip has ports which are used to link to other switch boards or hosts. The entities in the network that are likely to fail or recover during normal operation are the links between switching elements. In this cluster there is a requirement to complete the repair action, which in this particular case is the update of tables providing routing function on the host adapters, within, for example, two minutes of failure. Whenever a link fails, the centralized network manager is informed by the hardware. Once the processing of a repair action is started, it needs to be completed before any new event is handled. As a result it becomes necessary to collect all events before starting the repair action when multiple faults occur substantially simultaneously. In this example, such a situation would arise when a switch board loses power. In this cluster, the hardware notifications are received as multiple link outages which are received sequentially by the network manager. These notifications, along with other notifications which may include link up events are queued up at the network manager. In this example, a recovered link will also cause an action to be taken for reinstating the link into the network.

The steps in the implementation of FIG. 12 are as follows:

The network manager (NM) receives a link outage event 1200, thus entering link collection phase, and pushes the link onto a Status Change List of links 1210;

### ↓

The network manager waits T seconds to see if there is any more link outage event in the centralized message queue 1220 (T being, e.g., 5 seconds);

### ↓

If there is one, then the network manager waits until there is no more event in the last T seconds period;

### ↓

Since it is possible for a link to have recovered during this time, the network manager looks for any pending link up events for T seconds 1230;

### ↓

If found, the network manager collects all pending link up events 1240 until there are no more of them for T seconds;

### ↓

The network manager will then go back to check for pending link down events, without waiting for any amount of time 1250;

### ↓

If there are, then the link event information is pushed into the status change list 1260 and processing returns to determine whether another new link event of the same type has been received in the next T seconds 1220. Otherwise, the network manager enters the analysis phase 1270.

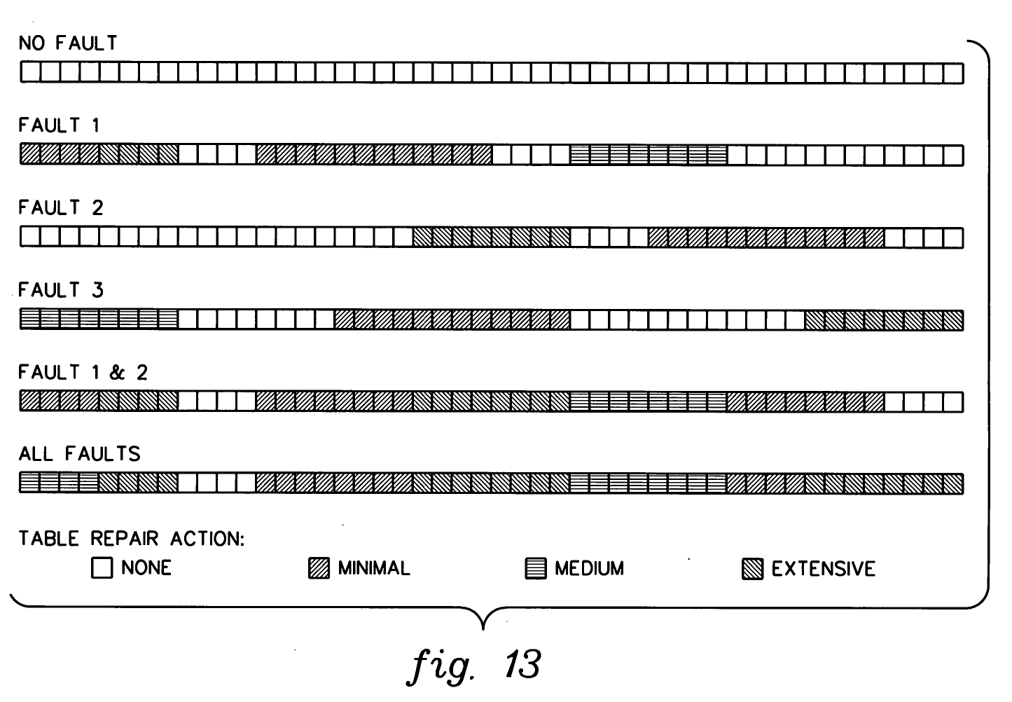

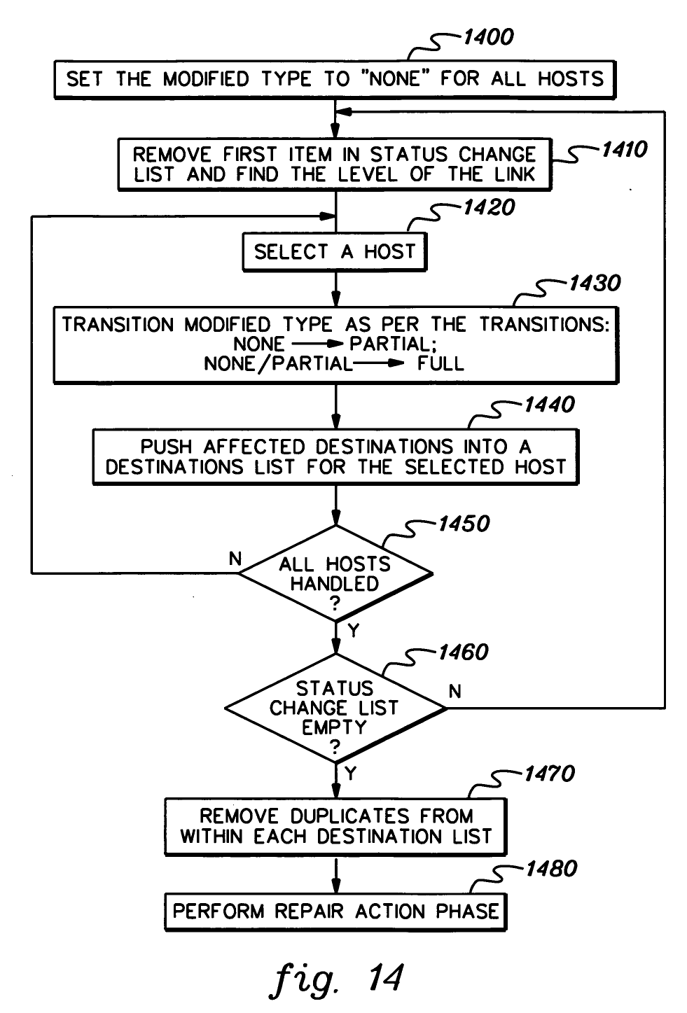

FIG. 13 illustrates an example consolidation of three faulty link events seen at substantially the same time, i.e., within a predefined time interval T of each other (e.g., 5 seconds). Each depicted square or cell represents a host node in the network. While a white cell denotes a host which is not effected by a faulty line event, minimal, medium and extensive effects are separately shaded. When consolidating the effect of multiple fault events, a host node can be removed from the list for further consolidation once the node reaches the extreme state (i.e., modification type FULL) in any stage of processing, thus simplifying consideration of the multiple substantially simultaneous fault events.

FIG. 14 depicts one embodiment of a process for consolidating multiple fault/recovery events, in accordance with an aspect of the present invention. Specifically, this flowchart depicts an analysis phase wherein a determination of the modification type for each host node is made. Processing begins by setting the modify type to NONE for each host node of the network 1400. A first item in the Status Change List is then removed and the level of the link event is identified 1410. A host node is selected 1420, and the modification type for that host node is transitioned depending upon the link level 1430. Transitioning based on link level is described below with reference to FIGS. 15A & 15B. Once the modification type for the particular node is identified, the effected destinations are pushed onto a destination list for that host node 1440. The network manager determines whether all hosts have been handled 1450, and if “no”, repeats the process for each host node in the network. Once all host nodes have been handled for the particular link event, then the network manager determines whether the Status Change List is empty 1460. If “no”, then the network manager repeats the process for the next link event item in the Status Change List. Otherwise, the network manager removes any duplicates from within each destination list of the plurality of host nodes 1470, and executes a repair action phase for the effected nodes, as described above.

FIGS. 15A & 15B are a flowchart of one embodiment of processing for determining a modification type for each host node of the network in step 1430 of FIG. 14. As noted, the link level of a link event is identified 1410 and the transition depends upon the particular link level. If the link event is at level 0, then the network manager determines whether the link event relates to a link connected to the host node at issue 1500. If “yes”, then that host node is transitioned from NONE to FULL modification type 1505. If the link is not connected to the particular host node selected, then processing determines whether that host node is already in a modification type FULL state 1510. If “yes”, then the transition processing is finished; otherwise, the particular host modification type is set to PARTIAL 1515. If the link event is at level 1, then the network manager determines whether the link's chip is connected to the particular host 1520. If “yes”, then that host is set to modification type FULL 1525. Otherwise, the network manager determines whether the host modification type is already FULL 1530, and if “yes”, no action is taken. Otherwise, the host is transitioned to modify type PARTIAL 1535.

If the link event is at level 2, then the network manager determines whether the link's board is connected to the particular host node 1540, and if “yes”, sets the host node's status to modification type FULL 1545. Otherwise, the manager determines whether the host modification type is already FULL 1550, and if “yes”, processing is complete. If the host modification type is not already FULL, then it is set to PARTIAL 1555.

If the link event is at level 3, then the network manager determines whether there are any secondary switch boards 1560. If “no”, then the host modification type is set to FULL 1565. If there are secondary switch boards, a determination is made whether the link's block is connected to the particular host node 1570, and if “yes”, then that host is set to modification type FULL 1575. Otherwise, the network manager determines whether the host is already modification type FULL, and if “yes”, transition step processing is complete for the particular node. If not already FULL, the host's modification type is set to PARTIAL 1585.

If the link event is at level 4, the network manager again inquires whether there are any secondary switch boards 1590, and if “no”, sets the host modification type to FULL 1595. Otherwise, the network manager determines whether the link's chip is connected to the host block 1600, and if “yes”, the host is set to modification type FULL 1605. If the link's chip is not connected to the host block, then a determination is made whether the host is already at modification type FULL, and if so, transition step processing for the particular host node is complete. Otherwise, the host modification type is set to PARTIAL 1615.

Finally, if the link event is at level 5 of the 5 level network of interconnected nodes depicted in FIGS. 7 & 8, then the particular host under consideration is set modification type FULL 1620.

When a node is in modification type FULL, the entire path table is processed for the repair action, whereas when the modification type of a host is PARTIAL, only the particular destinations in the destination list for that host are processed. Whatever the type of modification required, the potentially effected routes can be examined in one of three ways as noted above, i.e., a hop-by-hop checking for faulty links on the route, algebraically examining the routes using a routing algorithm, or constructing a route mask for the combination of faulty links, and applying the masks to the potentially effected routes.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A communications network, comprising:
a network of interconnected nodes, the nodes being at least partially interconnected by links, and being adapted to communicate by transmitting packets over the links;
a network interface associated with each node, each network interface defining a plurality of routes for transferring packets from the associated node as source node to a destination node, and further comprising path status indicators for indicating whether a route is usable or is unusable as being associated with a fault; and
a network manager for monitoring the network of interconnected nodes and noting a link event therein, and responsive thereto, for determining, with reference to an ascertained link level within the network of the link event, path status indicator updates to be provided to the respective network interfaces of effected nodes in the network of interconnected nodes.

2. The communications network of claim 1, wherein the network manager updates the path status indicators of the respective network interfaces of effected nodes by initially determining the link level within the network of the link event and creating at least one subset of effected nodes employing the link level of the link event, the at least one subset characterizing a modification type required for effected nodes within the subset, and for each node of each subset of effected nodes, the network manager generates updates to the path status indicators of the effected node employing the type of link event, wherein the link event comprises one of a link failure or a link recovery.

3. The communications network of claim 2, wherein the creating comprises creating at least two subsets of effected nodes, a first subset comprising a modification type FULL, identifying nodes requiring a full analysis of source-destination routes, and a modification type PARTIAL, identifying particular source-destination routes for analysis that may have been effected by the link event.

4. The communications network of claim 1, wherein the network manager is adapted to identify the existence of multiple link events within the network within a defined time interval of each other, and collectively analyze the multiple link events in determining path status indicator updates to be provided to the respective network interfaces of effected nodes in the network.

5. The communications network of claim 4, wherein the network manager is adapted to collectively analyze the multiple link events by identifying the link level within the network of each link event, and for each node of the network, determine a modification type required for the node based on the link events' link levels and create an effected destinations list, and thereafter, to remove duplicates from the effected destinations list of each node prior to determining path status indicator updates required for that effected node.

6. The communications network of claim 5, wherein the network manager is adapted to collectively analyze the multiple link events by initially setting the modification type of each node to NONE, and then determine for each node of the network and each link event whether to transition the node's modification type to PARTIAL or FULL based on the link level within the network of the link event, and to store effected destinations into a destination list for that node, repeating the transition and store process for each link event.

7. The communications network of claim 6, wherein after a respective node's modification type has transitioned to FULL, the modification type remains FULL for use in subsequent full analysis of the node's source-destination routes and determination of path status indicator updates responsive to the multiple link events.

8. A method of maintaining communication among a plurality of nodes in a network, the method comprising:
defining a plurality of static routes for transferring a packet from a respective node as source node to a destination node in the network;
monitoring the network to identify a link event therein;
providing path status indicators to at least some nodes of the plurality of nodes for indicating whether a source-destination route is usable or is unusable as being associated with a link fault; and
employing a network manager to monitor the network for link events, and upon noting a link event, for determining, with reference to an ascertained link level within the network of the link event, path status indicator updates to be provided to the respective network interface of effected nodes of the network of interconnected nodes.

9. The method of claim 8, wherein the network manager updates the path status indicators of respective network interfaces of effected nodes by initially determining the link level within the network of the link event, and creating at least one subset of effected nodes employing the link level of the link event, the at least one subset characterizing a modification type required for effected nodes within the subset, and for each node of each subset of effected nodes, the network manager generates updates to the path status indicators of the effected node employing the type of link event, wherein the link event comprises one of a link failure or a link recovery.

10. The method of claim 9, wherein the creating comprises creating at least two subsets of effected nodes, a first subset comprising a modification type FULL, identifying nodes requiring a full analysis of source-destination routes, and a modification type PARTIAL, identifying particular source-destination routes for analysis that may have been effected by the link event.

11. The method of claim 8, further comprising employing the network manager to monitor the network for link events, and identify the existence of multiple link events within the network within a defined time interval of each other, and collectively analyze the multiple link events in determining path status indicator updates to be provided to the respective network interfaces of effected nodes in the network.

12. The method of claim 11, further comprising employing the network manager to collectively analyze the multiple link events by identifying the link level within the network of each link event, and for each node of the network, determining a modification type required for the node based on the link events' link levels and create an effected destinations list, and thereafter, to remove duplicates from the effected destinations list of each node prior to determining path status indicator updates required for that effected node.

13. The method of claim 12, further comprising employing the network manager to collectively analyze the multiple link events by initially setting the modification type of each node to NONE, and then determining for each node of the network and each link event, whether to transition node's modification type to PARTIAL or FULL based on the link level within the network of the link event, and to store effected destinations into a destination list for that node, repeating the transitioning and storing for each link event.

14. The method of claim 13, further comprising after a respective node's modification type has transitioned to FULL, maintaining the modification type FULL for use in subsequent full analysis of the node's source-destination routes and determination of path status indicator updates responsive to the multiple link events.

15. At least one program storage device readable by a machine, tangibly embodying at least one program of instructions executable by the machine to perform a method of maintaining communication among a plurality of nodes in a network of interconnected nodes, the method comprising:
defining a plurality of static routes for transferring a packet from a respective node as source node to a destination node in the network;
monitoring the network to identify a link event therein;
providing path status indicators to at least some nodes of the plurality of nodes for indicating whether a source-destination route is usable or is unusable as being associated with a link fault; and
employing a network manager to monitor the network for link events, and upon noting a link event, for determining, with reference to an ascertained link level within the network of the link event, path status indicator updates to be provided to the respective network interface of effected nodes of the network of interconnected nodes.

16. The at least one program storage device of claim 15, wherein the network manager updates the path status indicators of respective network interfaces of effected nodes by initially determining the link level within the network of the link event, and creating at least one subset of effected nodes employing the link level of the link event, the at least one subset characterizing a modification type required for effected nodes within the subset, and for each node of each subset of effected nodes, the network manager generates updates to the path status indicators of the effected node employing the type of link event, wherein the link event comprises one of a link failure or a link recovery.

17. The at least one program storage device of claim 16, wherein the creating comprises creating at least two subsets of effected nodes, a first subset comprising a modification type FULL, identifying nodes requiring a full analysis of source-destination routes, and a modification type PARTIAL, identifying particular source-destination routes for analysis that may have been effected by the link event.

18. The at least one program storage device of claim 15, further comprising employing the network manager to monitor the network for link events, and identify the existence of multiple link events within the network within a defined time interval of each other, and collectively analyze the multiple link events in determining path status indicator updates to be provided to the respective network interfaces of effected nodes in the network.

19. The at least one program storage device of claim 18, further comprising employing the network manager to collectively analyze the multiple link events by identifying the link level within the network of each link event, and for each node of the network, determining a modification type required for the node based on the link events' link levels and create an effected destinations list, and thereafter, to remove duplicates from the effected destinations list of each node prior to determining path status indicator updates required for that effected node.

20. The at least one program storage device of claim 19, further comprising employing the network manager to collectively analyze the multiple link events by initially setting the modification type of each node to NONE, and then determining for each node of the network and each link event, whether to transition node's modification type to PARTIAL or FULL based on the link level within the network of the link event, and to store effected destinations into a destination list for that node, repeating the transitioning and storing for each link event.
